(19) United States
(12) Patent Application Publication
(10) Pub. No.: US 2015/0100686 A1
(43) Pub. Date: Apr. 9, 2015

(54) INFORMATION PROCESSING SYSTEM, SITE MONITORING APPARATUS, AND INFORMATION PROCESSING METHOD

(71) Applicant: CANON KABUSHIKI KAISHA, Tokyo (JP)

(72) Inventor: Yuka Sakurai, Yokohama-shi (JP)

(21) Appl. No.: 14/491,265

(22) Filed: Sep. 19, 2014

(30) Foreign Application Priority Data
Oct. 7, 2013 (JP) 2013-210589

(51) Int. Cl. H04L 12/26

(52) U.S. Cl. CPC H04L 43/0876
USPC 709/224

(57) ABSTRACT

In order to appropriately control the device information of devices managed by a plurality of systems, an information processing system comprises a site monitoring apparatus configured to collect device information from image forming apparatuses and a usage status analysis system configured to receive the device information from the site monitoring apparatus via a network and to analyze the received device information. The usage status analysis system receives specifying information for specifying a device list from the site monitoring apparatus, and transmits, to the site monitoring apparatus, update information that has been generated based on the specifying information.

### BACKGROUND OF THE INVENTION

1. Field of the Invention

The present invention relates to a technique for managing devices monitored by a plurality of systems.

2. Description of the Related Art

In recent years, managed print services (MPS) are garnering attention as a solution for business offices, and their market size is expanding. MPS is an outsourcing service for constructing an optimum output environment after analyzing the current situation of the print output environment in a company, and continuously maintaining and operating that environment. Examples of MPS include remote maintenance systems intended to provide services relating to maintenance, and usage status analysis systems intended to provide services relating to usage status analysis.

A remote maintenance system is a system that monitors operating information collected from devices, and performs dispatch of servicemen, inventory control of expendables, and the like. The system also collects the counter information of the devices and uses the information for billing. As disclosed in Japanese Patent Laid-Open No. 2003-316674, it is often the case that the remote maintenance system has a configuration including a client apparatus that collects information on devices, and a server apparatus that manages the information collected by the client apparatus. In that case, the client apparatus and the server apparatus need to share the information such that they can recognize the same device. For this purpose, it is necessary to perform setting for each of the server apparatus and the client apparatus at the time of the initial installation. Since the remote maintenance system is also used for billing purposes, a serviceman directly goes to the location where the client apparatus is installed, and performs setting for the initial installation of the client apparatus. The initial installation includes the setting needed for the client apparatus to communicate with the server apparatus, the setting of the information on devices that are to be managed, and the like.

The usage status analysis system collects and analyzes, for example, the operating information and the counter information collected from the devices, and incident information acquired from an external system, and creates a report. It is often the case that the usage status analysis system has a configuration including a client apparatus that collects information on devices and a server apparatus that manages the information collected by the client apparatus. In that case, the client apparatus and the server apparatus need to share the information such that they can recognize the same device. However, many of customers who use usage status analysis in many cases manage a plurality of devices, and it is thus desirable that the initial installation can be done by performing setting only on the server side so as to minimize the time and effort.

The client apparatuses of these systems include mediating client apparatuses that not only transmit the information directly to their respective server apparatuses, but also collect information on a plurality of devices and transmit a collection of the information to the server apparatuses. It is also often the case that the remote maintenance system and the usage status analysis system are subscribed at the same time. Thus, there is also a client apparatus whose function can be expanded in the form of a plug-in such that a client apparatus does not need to be provided for each system. For the plug-in type client apparatus, it is often the case that the same data is handled also by systems having different purposes. For this reason, in order to collect the information on devices efficiently, the collection of information from the devices is performed for each client apparatus, and the transmission of information to the server is performed so as to match the schedule of each plug-in. In addition, the maximum number of devices to be managed may be defined for the client apparatus. When a number of devices that is greater than the maximum number is to be managed, a plurality of client apparatuses are installed in the customer environment.

However, each of the above-described plurality of different systems needs to operate independently, and it is therefore necessary to perform various settings for each system. Furthermore, a person in charge for performing these various settings often differs from one system to the other. This also applies to the plug-in type client apparatus. Accordingly, the setting for devices to be managed is performed for each system when a plurality of client apparatuses are installed, and therefore, there may be cases where some of the devices may be managed by different client apparatuses. For example, there may be a case where a device that is managed by a client apparatus A for the remote maintenance system is managed by a client apparatus B for the usage status analysis system. In such a case, the transmission schedule is different for each client apparatus (i.e., for each system), and therefore, the counter value of the same device differs from system to system. Accordingly, for example, when the counter used for billing and the counter that is output into a report are different, the customer may be confused, which may lead to a complaint.

### SUMMARY OF THE INVENTION

According to one aspect of the present invention, an information processing system comprises: a site monitoring apparatus configured to collect device information from image forming apparatuses; and a usage status analysis system configured to receive the device information from the site monitoring apparatus via a network and to analyze the received device information, wherein the site monitoring apparatus includes: a first management unit configured to manage a first device list including an image forming apparatus that is to be monitored by a first module for providing a function of communicating with a monitoring system; a second management unit configured to manage a second device list including an image forming apparatus that is to be monitored by a second module for providing a function of communicating with the usage status analysis system; a first transmission unit configured to transmit specifying information for specifying the first device list to the usage status analysis system by using the function of the second module; a first reception unit configured to receive update information conforming to the specifying information from the usage status analysis system; and an update unit configured to update the second device list managed by the second management unit by using the received update information, the usage status analysis system includes: a second reception unit configured to receive the specifying information from the site monitoring apparatus; and a second transmission unit configured to transmit, to the site monitoring apparatus, the update information that has been generated based on the specifying information.

According to another aspect of the present invention, a site monitoring apparatus comprises: a first management unit configured to manage a first device list including an image forming apparatus that is to be monitored by a first module for providing a function of communicating with a monitoring system; a second management unit configured to manage a second device list including an image forming apparatus that is to be monitored by a second module for providing a function of communicating with a usage status analysis system; a transmission unit configured to transmit specifying information for specifying the first device list to the usage status analysis system by using the function of the second module; a reception unit configured to receive update information conforming to the specifying information from the usage status analysis system; and an update unit configured to update the second device list managed by the second management unit by using the received update information.

According to still another aspect of the present invention, an information processing method performed in an information processing system includes: a site monitoring apparatus configured to collect device information from image forming apparatuses; and a usage status analysis system configured to receive the device information from the site monitoring apparatus via a network and to analyze the received device information, wherein the site monitoring apparatus includes: a first management unit configured to manage a first device list including an image forming apparatus that is to be monitored by a first module for providing a function of communicating with a monitoring system; and a second management unit configured to manage a second device list including an image forming apparatus that is to be monitored by a second module for providing a function of communicating with a usage status analysis system, the information processing method comprises: transmitting, by the site monitoring apparatus, specifying information for specifying the first device list to the usage status analysis system by using the function of the second module; receiving, by the usage status analysis system, the specifying information from the site monitoring apparatus; transmitting, by the usage status analysis system, update information that has been generated based on the specifying information to the site monitoring apparatus, receiving, by the site monitoring apparatus, the update information conforming to the specifying information from the usage status analysis system; and updating, by the site monitoring apparatus, the second device list managed by the second management unit by using the received update information.

According to yet another aspect of the present invention, an information processing method performed in a site monitoring apparatus includes: a first management unit configured to manage a first device list including an image forming apparatus that is to be monitored by a first module for providing a function of communicating with a monitoring system; and a second management unit configured to manage a second device list including an image forming apparatus that is to be monitored by a second module for providing a function of communicating with a usage status analysis system, the method comprises: transmitting specifying information for specifying the first device list to the usage status analysis system by using the function of the second module; receiving update information conforming to the specifying information from the usage status analysis system; and updating the second device list managed by the second management unit by using the received update information.

The present invention provides a technique for appropriately controlling device information of devices that are managed by a plurality of systems.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustratively showing an overall configuration of a system according to a first embodiment.

FIG. 2 is a diagram showing a hardware configuration of a site monitoring apparatus, a management apparatus, and an analysis apparatus.

FIG. 3 is a diagram showing an example of a hardware configuration of a device to be managed.

FIG. 4 is a diagram showing an example of a software configuration of the site monitoring apparatus.

FIG. 5 is a diagram showing a software configuration of the management apparatus.

FIG. 6 is a diagram showing an example of a software configuration of the analysis apparatus.

FIG. 7 is a diagram showing management device lists that are set in the management apparatus.

FIG. 8 is a diagram showing management device lists that are set in the analysis apparatus.

FIGS. 9A and 9B are diagrams showing management device lists that are set in the site monitoring apparatuses.

FIG. 10 is a diagram showing an example of a UI screen that displays a management device list of the site monitoring apparatus.

FIG. 11 is a flowchart illustrating an operation for updating the management device list in the site monitoring apparatus.

FIG. 12 is a flowchart illustrating an operation for changing the management device list in the analysis apparatus.

FIG. 13 is a flowchart illustrating an operation for setting the management device list in the site monitoring apparatus.

FIG. 14 is a flowchart illustrating an operation for updating the management device list in an analysis apparatus according to a variation.

FIG. 15 is a flowchart illustrating an operation for setting the management device list in a site monitoring apparatus according to a variation.

### DESCRIPTION OF THE EMBODIMENTS

Hereinafter, preferred embodiments of the present invention will be described in detail with reference to the drawings. Note that the following embodiments are merely by way of example, and are not intended to limit the scope of the invention.

### First Embodiment

A first embodiment of a management apparatus according to the present invention will be described below, taking, as an example, an information processing system that collects various types of information from devices to be managed, and transmits the collected information to a usage status analysis system and a monitoring system.

### System Configuration

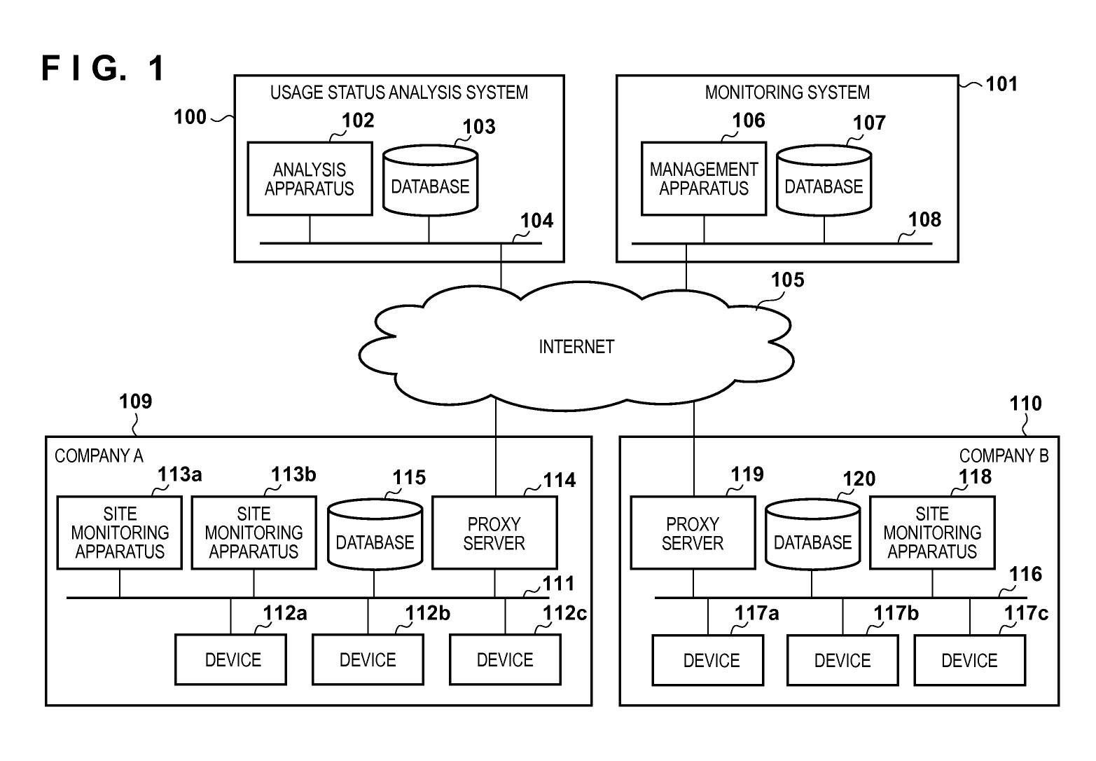

FIG. 1 is a diagram illustratively showing an overall configuration of the information processing system according to the first embodiment. The information processing system includes a usage status analysis system 100, a monitoring system 101, and customer systems 109 and 110, which are communicably connected to one another, for example, via the Internet 105.

The usage status analysis system 100 is a system intended to provide a service for collecting and aggregating various types of information on devices 112 and 117 on the customer side, and creating the result of analysis in the form of a report. The monitoring system 101 collects the operating information of the devices 112 and 117 on the customer side via the site monitoring apparatus, and provides a service relating to the ordering of expendables and maintenance such as emergency maintenance. The customer systems 109 and 110 are in-house systems of the customer, and each of the in-house systems includes devices to be managed and a site monitoring apparatus that monitors the device. Note that the first embodiment is described assuming that the devices to be managed are an image forming apparatuses such as a multifunction peripheral (MFP) and a laser beam printer (LBP).

The usage status analysis system 100 includes an analysis apparatus 102 and a database 103. The database 103 stores various types of data (e.g., a counter, a job history, an incident, and a fault history) on the devices 112 and 117 that is necessary for a report. The database 103 also stores a report template, the information for collecting the data on the devices 112 and 117, and the like. The analysis apparatus 102 and the database 103 are connected by a LAN 104, and the LAN 104 is connected to the Internet 105. Note that the database 103 may also be configured to be a constituent element in the analysis apparatus 102. Furthermore, the database 103 may be present at any other location by way of the Internet 105 as long as it can be accessed from the analysis apparatus 102.

The analysis apparatus 102 has a function of collecting, storing, and processing the information on devices to be managed by the usage status analysis system 100 and the information necessary for a report from site monitoring apparatuses 113 and 118, which will be described below, and providing a usage status result to the outside. As described above, examples of the information necessary for a report include a job history, counter information (e.g., usage frequency), operating information, and incident information. The analysis apparatus 102 provides, to a PC connected thereto via the Internet 105, a WEB page for browsing the information stored in the database 103 or the processed information. This WEB page is provided such that the browsing content is limited according to the authority by using user authentication. Furthermore, the WEB page is configured such that a part of the data can be changed.

A person in charge having a specific authority on the WEB page registers various types of information into the analysis apparatus 102 on a customer-by-customer basis. Examples of the information to be registered include devices 112 (112a to 112c) and 117 (117a to 117c) that are to be managed by the usage status analysis system 100, and site monitoring apparatuses 113 (113a to 113b) and 118 for collecting the information on the devices 112 and 117. The person in charge can associate the registered devices 112 and 117 with the site monitoring apparatuses 113 and 118 on a function-by-function basis. On the other hand, based on the associated information, the site monitoring apparatus 113 collects various types of information from the device 112, and transmits the collected information to the analysis apparatus 102 and the management apparatus 106. Likewise, based on the associated information, the site monitoring apparatus 118 collects various types of information from the devices 117, and transmits the collected information to the analysis apparatus 102 and the management apparatus 106.

The monitoring system 101 includes a management apparatus 106 and a database 107. The database 107 stores various types of information that will be necessary for monitoring, and the information collected from the customer side, including, the device counter, fault history information, and a fault pattern table. The management apparatus 106 and the database 107 are connected by a LAN 108, and the LAN 108 is connected to the Internet 105. Note that the database 107 may be configured to be a constituent element in the management apparatus 106. Furthermore, the database 107 may be present at any other location by way of the Internet 105 as long as it can be accessed from the management apparatus 106.

The management apparatus 106 has a function of collecting, from the site monitoring apparatuses 113 and 118, the information on devices to be managed, the information (including fault information) indicating the operating state, storing and processing these pieces of information, and providing a warning or the like to the outside. Also, the management apparatus 106 has a function of distributing these pieces of information to the outside. Examples of the information indicating the operating state include toner depletion, an open door, drum replacement, the absence of a cartridge, cooling fan abnormality, substrate abnormality, a stained platen glass, no staples, and the lack of light amount of a paper feed sensor. Further examples include a font memory overflow, a rendering error, fixing device abnormality, counter abnormality, double-sided unit abnormality, and paper jam. Further, examples of the counter information include a billing counter to be billed, a department counter aggregated according to the department of the customer, a size-specific counter aggregated according to the sheet size, and a part counter indicating the degree of wearing of the parts in the devices.

The management apparatus 106 is configured to be able to merge the settings regarding the devices to be managed and the monitoring therefor, and manage them in a centralized manner. Also, the management apparatus 106 provides, to a PC connected thereto via the Internet 105, a WEB page for browsing the information stored in the database 107 or the processed information. This WEB page is provided such that the browsing content is limited according to the authority by using user authentication. Furthermore, the management apparatus 106 is configured to be able to change a part of the data via the WEB page.

A person in charge having a specific authority registers devices to be managed by the monitoring system 101 on the WEB page provided by the management apparatus 106 or via a Web Service I/F. Note that when the information on a device that is not to be managed is transmitted, the management apparatus 106 discards the information without storing it in the database 107.

Next, the system configuration on the customer side will be described. FIG. 1 illustratively shows customer systems 109 and 110 of a plurality of different customers, namely, Company A and Company B, respectively. Note that the customer system 110 has substantially the same configuration as that of the customer system 109 except that a single site monitoring apparatus is disposed, and therefore, the description thereof has been omitted.

In the customer system 109, the device 112 (112a to 112c) that is connected to the LAN 111 connected to the Internet 105 is monitored by the site monitoring apparatus 113 (113a to 113b). Each of the site monitoring apparatuses 113a and 113b communicates with the usage status analysis system 100 and the monitoring system 101 via a proxy server 114 by way of the Internet 105.

The site monitoring apparatus 113 saves the information collected from the device 112 and the result of processing the collected information in the database 115. The site monitoring apparatus 113 also saves the information to be distributed to the device 112 and various types of setting information for acquiring information from the device 112 in the database 115. Although the database 115 is connected to the site monitoring apparatus 113 via the LAN 111 in the drawing, it may be configured to be disposed inside the site monitoring apparatus 113. Furthermore, the database 115 may be present at any other location by way of the Internet 105 as long as it can be accessed from the site monitoring apparatus 113.

The site monitoring apparatus 113 temporarily saves the information received from the device 112 in the database 115, and transmits the information to the monitoring system 101 and the usage status analysis system 100. The timing of transmission to the monitoring system 101 and the usage status analysis system 100 is determined by the schedule specified by the management apparatus 106 and the analysis apparatus 102. Note that the timing of acquiring the various types of information from the device 112 is autonomously set by the site monitoring apparatus 113 so as to be in time to meet the timing of transmission to the monitoring system 101 and the usage status analysis system 100.

Here, each of the site monitoring apparatuses 113a and 113b is a plug-in type monitoring apparatus configured such that each module can be added in the form of a plug-in. In the first embodiment, a usage status analysis module that controls information exchanged with the usage status analysis system 100, and a remote monitoring module that controls information exchanged with the monitoring system 101 are set. Of course, another plug-in may be set further. Furthermore, the site monitoring apparatus 113 also has a function of automatically searching for a device connected on the LAN 111, transmitting the search result to the usage status analysis system 100, and registering the device.

Each of the site monitoring apparatuses 113a and 113b holds a management device list of devices for which various types of information are transmitted to the monitoring system 101, and a management device list showing a list of devices for which various types of information are transmitted to the usage status analysis system 100. The site monitoring apparatuses 113a and 113b collect various types of information from the devices included in these management device lists, and transmit the information to the monitoring system 101 and the usage status analysis system 100.

Here, the management device list of the usage status analysis system 100 may be preferably distributed from the analysis apparatus 102 to the site monitoring apparatuses 113a and 113b. On the other hand, it is desirable that the management device list of the monitoring system 101 is directly set to the site monitoring apparatuses 113a and 113b. The reason for this is that the monitoring system 101 collects the counter to be billed, and thus the devices to be managed thereby need to be registered precisely. Specifically, a maintenance personnel of the company operating the monitoring system 101 goes to the location where the site monitoring apparatuses 113a and 113b are installed, and registers the managed devices.

Internal Configuration of Various Apparatuses in System

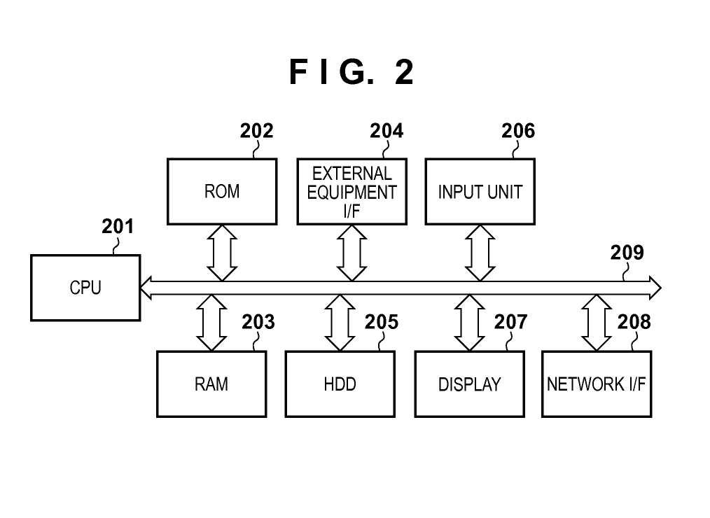

FIG. 2 is a diagram showing the hardware configuration of the site monitoring apparatus, the management apparatus, and the analysis apparatus. It is assumed here that each of the apparatuses serves its function by executing a predetermined program on an information processing apparatus (PC).

A CPU 201 executes an application program, a printer driver program, an operating system (OS), and the like stored in a hard disk drive (HDD) 205. Note that although only one CPU is shown in the drawing, it is possible to adopt a configuration in which a plurality of CPUs are used. A ROM 202 is a non-rewritable storage unit that stores therein a basic I/O program, a program that governs various processes performed on the apparatus, and data. A RAM 203 temporarily stores the information, files, and the like that are necessary for execution of the programs, and functions as a main memory, a work area, or the like of the CPU 201. Note that the processes at the steps in the flowchart described below are implemented by the CPU 201 executing the predetermined program stored in the HDD 205.

An external equipment interface (I/F) 204 is an interface for connecting an external storage device or the like. By connecting an external storage device, the program and the like stored in the external storage device or in a storage medium can be loaded onto the information processing apparatus. Note that any medium such as a FD, a CD, a DVD, a semiconductor memory card, or a magneto-optical (MO) disk can be used as the storage medium.

The hard disk drive (HDD) 205 stores programs and data for executing the processes performed by the information processing apparatus, and temporary data. The HDD 205 also stores the information relating to the devices 112 and 117 that are to be managed. Furthermore, the HDD 205 also stores various types of data such as the data collected from the devices 112 and 117, a report template, and report data. Note that although only one HDD is shown in the drawing, it is possible to adopt a configuration in which a plurality of HDDs are used.

An input unit 206 is an apparatus for receiving an instruction input from the user, and is a keyboard or a pointing device. For example, the user (person in charge) of each of the systems performs input instructions such as setting and operation to the information processing apparatus via the input unit 206.

A display 207 is an apparatus that performs display and output, and displays the instruction input from the input unit 206 and the state and the setting of the devices 112 and 117 that are to be managed. For example, the display 207 is a liquid crystal display device (LCD) that displays a display screen generated by a graphic chip based on a rendering command issued by the application via the OS structure.

A network interface (I/F) 208 connects to the LAN and the Internet by way of a network, and exchanges information with the outside. The information processing apparatus exchanges data with an external apparatus via the interface 208. A system bus 209 is a functional unit that controls data transmission/reception between the above-described functional units.

Hardware Configuration of Device

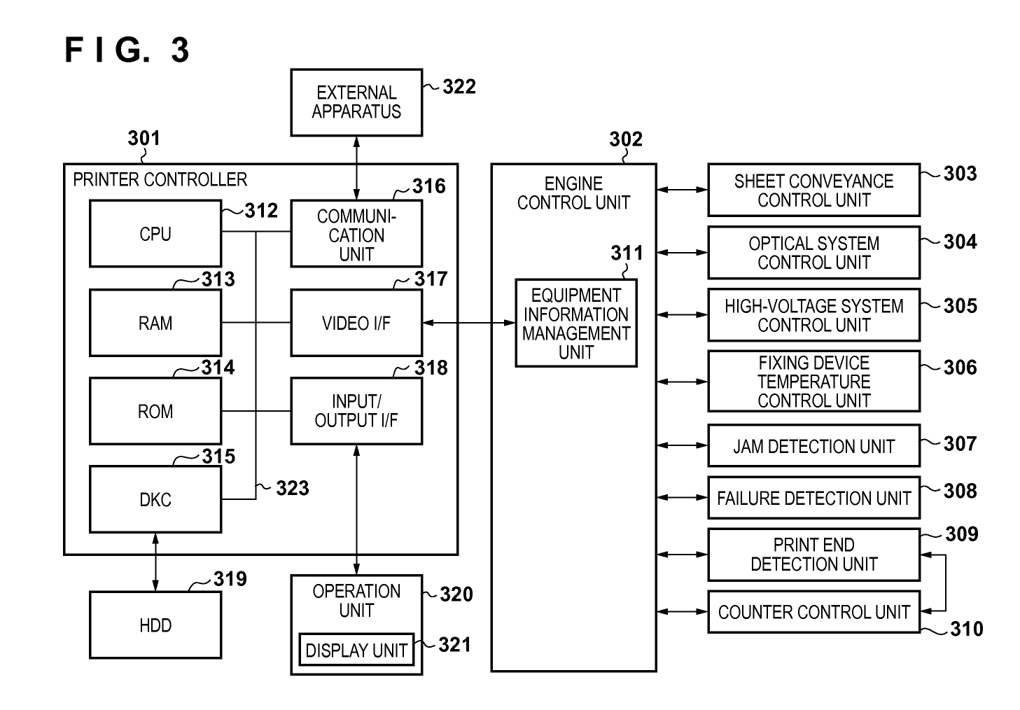

FIG. 3 is a diagram showing an example of the hardware configuration of a device to be managed. As described above, the devices 112 and 117 are image forming apparatuses in the first embodiment, and the block configuration diagram of a printer control unit and the peripheral portion thereof is shown in FIG. 3.

A printer controller 301 includes an external apparatus 322 such as a host computer and a communication unit 316 for executing transmission/reception of various types of data by using a predetermined protocol. In the first embodiment, the external apparatus 322 includes the site monitoring apparatuses 113 and 118, the analysis apparatus 102, the management apparatus 106, and so forth. Additionally, the printer controller 301 includes a video I/F 317 for expanding the received image data into information that can be recorded by a printer and performing data communication with a printer engine control unit 302.

A CPU 312 executes a control program stored in a ROM 314 or an external HDD 319, and performs overall control of access between the functional units connected to a system bus 323. A RAM 313 functions as a main memory, a work area, or the like of the CPU 312.

A disk controller (DKC) 315 controls access to the external hard disk drive (HDD) 319 that stores a boot program, various applications, font data, user files, setting files, and so forth.

An operation unit 320 includes a display unit 321 for providing information to the operator, an input unit, such as a keyboard, for receiving an instruction input from the operator, and the like. The printer controller 301 causes the provision of information to the operator and the instruction input from the operator to be performed via an input/output I/F 318.

The engine control unit 302 performs communication with the printer controller 301 and controls the units of the printer engine. A sheet conveyance control unit 303 is a functional unit that feeds and conveys a sheet to be printed, and performs sheet conveyance in accordance with instructions from the engine control unit 302 until the printed sheet is discharged. An optical system control unit 304 is a functional unit that performs the driving of a scanner motor and the ON/OFF control of laser in accordance with instructions from the engine control unit 302. A high-voltage system control unit 305 is a functional unit that performs high-voltage output required for an electrophotographic process such as charging, development, and transfer, in accordance with instructions from the engine control unit 302.

A fixing device temperature control unit 306 is a functional unit that performs the temperature control of the fixing device in accordance with instructions from the engine control unit 302, and performs abnormality detection and the like for the fixing device. A jam detection unit 307 is a functional unit that detects a conveyance failure of the sheet during conveyance. A failure detection unit 308 detects a failure of the functional units in the printer. A print end detection unit 309 is a functional unit that detects that printing has been performed normally, and notifies the engine control unit 302 to that effect. A counter control unit 310 updates various types of counter information after printing.

Also, the engine control unit 302 includes an equipment information management unit 311 that manages the information on the units of the printer engine. In response to a request from the external apparatus 322, the equipment information management unit 311 acquires the counter information from the counter control unit 310, for example, and passes the acquired information to the printer controller 301 via the video I/F 317. Thereby, the counter information is transmitted to the external apparatus 322 via the communication unit 316. In addition to this, the equipment information management unit 311 also acquires the counter information from the units as appropriate when an information acquisition request is made from the external apparatus 322.

Furthermore, the equipment information management unit 311 also manages jam information notified from the jam detection unit 307 and error information notified from the failure detection unit 308. If an event notification request has been made from the external apparatus 322, these pieces of information are also transmitted to the external apparatus 322.

Software Configuration of Site Monitoring Apparatus

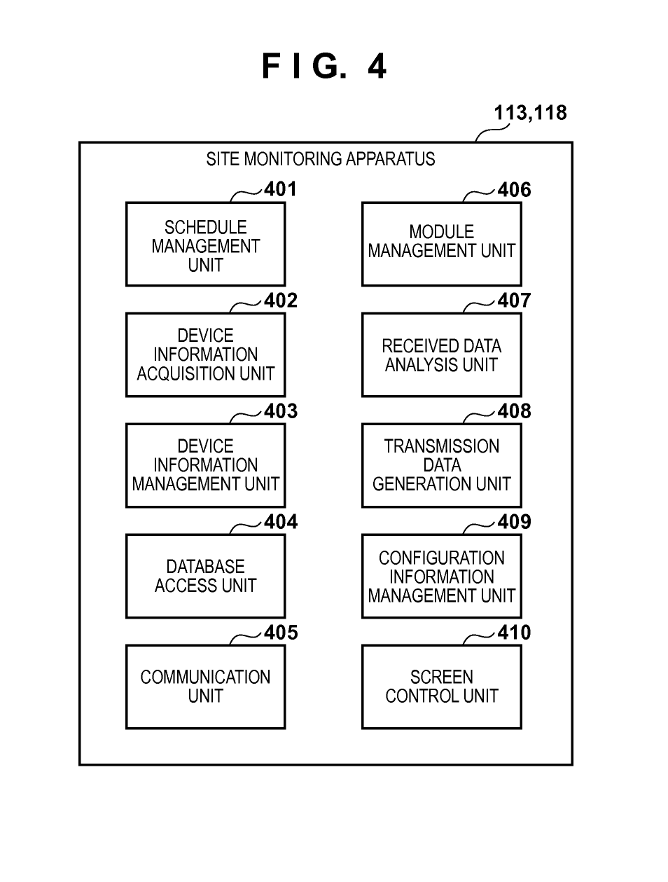

FIG. 4 is a diagram showing an example of the software configuration of the site monitoring apparatus. Note that the site monitoring apparatus 113 (113a, 113b) and 118 have substantially the same configuration, and therefore, the site monitoring apparatus 113 will be described below.

A schedule management unit 401 manages the processing schedule of the site monitoring apparatus 113. The processes to be controlled include processes performed in accordance with instructions from the management apparatus 106 and processes performed in accordance with instructions from the analysis apparatus 102. For these processes, timer control is performed in order to perform the processes periodically or at a specified time.

A device information acquisition unit 402 acquires information such as the operating information and job history of the device 112 from the device 112.

A device information management unit 403 manages the information of the device 112 acquired from the device information acquisition unit 402. These pieces of information are saved in the database 115 via a database access unit 404, which will be described below. The database access unit 404 is a functional unit that controls input/output to and from the database 115.

A communication unit 405 is a functional unit that performs data transmission/reception to and from an external apparatus such as the management apparatus 106, the analysis apparatus 102, and the device 112 via a network such as a LAN and the Internet.

A module management unit 406 manages the modules that perform control of the functions relating to the usage status analysis system 100 and the usage status analysis system 100. In the first embodiment, the module management unit 406 manages a usage status analysis module and a remote monitoring module.

The usage status analysis module has a function of acquiring the information on a device that is to be monitored by the usage status analysis system 100 from the device 112, and transmitting the acquired information to the usage status analysis system 100. On the other hand, the remote monitoring module has a function of acquiring the information on a device that is to be monitored by the monitoring system 101 from the device 112, and transmitting the acquired information to the monitoring system 101. Although a configuration that manages two modules is described in the first embodiment, it is also possible to adopt a configuration that additionally manages other modules. The module management unit 406 manages the management device lists for each module, and it is possible to set (add or delete) a device to be managed on a module-by-module basis.

A received data analysis unit 407 is a functional unit that analyzes the received data received from the management apparatus 106, the analysis apparatus 102, the device 112 via the communication unit 405, and transmits the received data to an appropriate processing unit.

A transmission data generation unit 408 generates transmission data in accordance with a communications protocol in response to a request from the functional units. The generated transmission data is transmitted to the management apparatus 106, the analysis apparatus 102, and the device 112 via the communication unit 405.

A configuration information management unit 409 manages the configuration information of the site monitoring apparatus 113. The configuration information includes client apparatus identification information (client apparatus ID), customer identification information (customer ID), an IP address, and so forth, which will be described below. At the time of communicating with the usage status analysis system 100 and the monitoring system 101, authentication is performed using the set client apparatus ID and an authentication key. A screen control unit 410 is a functional unit that performs the display control of a UI screen of the site monitoring apparatus 113.

Software Configuration of Management Apparatus

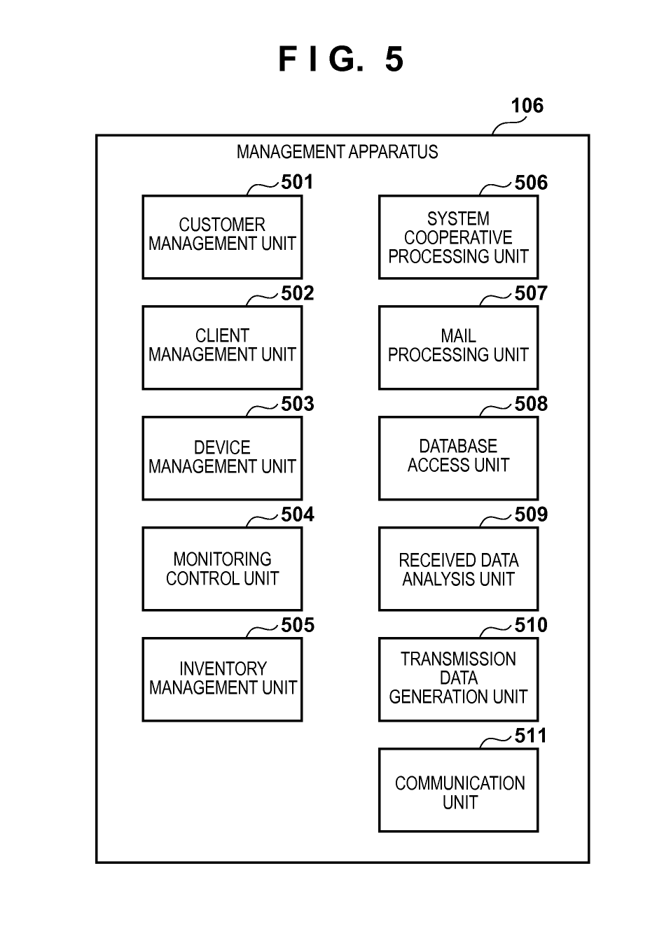

FIG. 5 is a diagram showing a software configuration of the management apparatus. A customer management unit 501 is a functional unit that manages a customer who is subscribing to the monitoring system 101. In the customer management unit 501, customer information such as the address of the customer, and the name and contact address of the administrator is managed in association with the corresponding customer ID.

A client management unit 502 manages the site monitoring apparatuses 113 and 118 installed on the customer side. In the client management unit 502, the client apparatus ID and the customer ID that are respectively assigned to the site monitoring apparatuses 113 and 118 are managed in association with each other. The client management unit 502 also manages the management device lists indicating the devices managed by the site monitoring apparatuses 113 and 118. Note that the data that is transmitted from the site monitoring apparatus and the devices 112 and 117 that are not registered in the management device lists is ignored.

A device management unit 503 manages the devices 112 and 117 that are managed by the management apparatus 106. For example, in the device management unit 503, information such as the IP address, the MAC address, the serial number, the product name, and the location of installation of the devices 112 and 117 is managed in association with the device IDs of the devices 112 and 117.

A monitoring control unit 504 performs control of the monitoring in the site monitoring apparatuses 113 and 118, including, for example, control of the schedule for acquiring the information and the monitoring content. Furthermore, the monitoring control unit 504 transmits, as needed, various instructions to the site monitoring apparatuses 113 and 118 via a transmission data generation unit 510 and a communication unit 511, which will be described below.

An inventory management unit 505 is a functional unit that manages the inventory of the parts and expendables used for the devices 112 and 117 to be managed.

A system cooperative processing unit 506 is a functional unit for transmitting/receiving the various types of data saved in the HDD via the Web Service I/F. A mail processing unit 507 is a functional unit that performs a predetermined mail notification to a pre-registered mail address. For example, a mail is transmitted when there is abnormality in the monitoring information of a device, or when the inventory of expendables has been depleted. A database access unit 508 is a functional unit that controls input/output to and from the database 107. A received data analysis unit 509 is a functional unit that analyzes the received data received from the site monitoring apparatuses 113 and 118, the analysis apparatus 102, the devices 112 and 117 via a communication unit 511, which will be described below. As a result of the analysis, the received data is transmitted to an appropriate functional unit.

A transmission data generation unit 510 is a functional unit that generates transmission data in accordance with a communications protocol in response to a request from the functional units. The generated transmission data is transmitted to the site monitoring apparatuses 113 and 118, the analysis apparatus 102, the devices 112 and 117 via the communication unit 511.

A communication unit 511 is a functional unit that perform data transmission/reception to and from an external apparatus such as the site monitoring apparatuses 113 and 118, the analysis apparatus 102, and the devices 112 and 117 via a network such as a LAN and the Internet.

Software Configuration of Analysis Apparatus

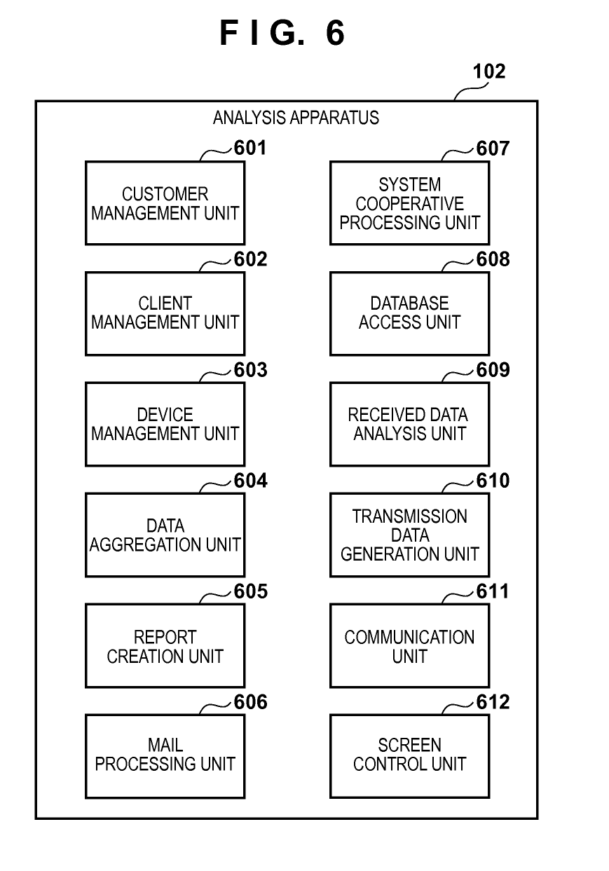

FIG. 6 is a diagram showing an example of the software configuration of the analysis apparatus. A customer management unit 601 is a functional unit that manages a customer who is subscribing to the analysis system 102. In the customer management unit 601, customer information such as the address of the customer, and the name and contact address of the administrator is managed in association with the corresponding customer ID.

A client management unit 602 manages various types of information on the site monitoring apparatuses 113 and 118. In the client management unit 602, the client apparatus ID and the customer ID that are respectively assigned to the site monitoring apparatuses 113 and 118 are managed in association with each other. The client management unit 602 also manages the management device lists indicating the devices managed by the site monitoring apparatuses 113 and 118. The management device lists are transmitted to the site monitoring apparatuses 113 and 118 as a response to a request from the site monitoring apparatuses 113 and 118, and set in the site monitoring apparatuses 113 and 118.

A device management unit 603 manages the devices 112 and 117 that are managed by the usage status analysis system 100. In the device management unit 603, information such as the IP address, the MAC address, the serial number, the product name, and the location of installation of the devices 112 and 117 is managed in association with the device IDs of the devices 112 and 117.

A data aggregation unit 604 aggregates the various types of information transmitted from the site monitoring apparatuses 113 and 118 as information for creating a report. The report creation unit 605 creates a report in a predetermined form from the information aggregated by the data aggregation unit 604.

A mail processing unit 606 is a functional unit that performs notification when a specific event has occurred in a pre-set mail address. A mail is transmitted, for example, when a new device is found by a search, when specific operating information has been notified, or when a failure has occurred in communication with the site monitoring apparatus. The mail notification is performed in the case of explicitly prompting the customer to perform an operation after the occurrence of an event.

A system cooperative processing unit 607 is a functional unit that exchanges information with an external apparatus. Here, the system cooperative processing unit 607 performs transmission/reception of the information held by the usage status analysis system 100 via the Web Service I/F of the usage status analysis system 100. A database access unit 608 is a functional unit that controls input/output to and from the database 103.

A received data analysis unit 609 is a functional unit that analyzes the received data received from the management apparatus 106, the site monitoring apparatuses 113 and 118, and the devices 112 and 117 via a communication unit 611, which will be described below. As a result of the analysis, the received data is transmitted to an appropriate functional unit.

A transmission data generation unit 610 is a functional unit that generates transmission data in accordance with a communications protocol in response to a request from the functional units. The generated transmission data is transmitted to the management apparatus 106, the site monitoring apparatuses 113 and 118, and the devices 112 and 117 via the communication unit 611.

A communication unit 611 is a functional unit that performs data transmission/reception to and from an external information processing apparatus such as the management apparatus 106, the site monitoring apparatuses 113 and 118, and the devices 112 and 117 via a network such as a LAN and the Internet. A screen control unit 612 is a functional unit that performs the display control of a UI screen of the analysis apparatus 102.

Management Device Lists in Management Apparatus and Analysis Apparatus

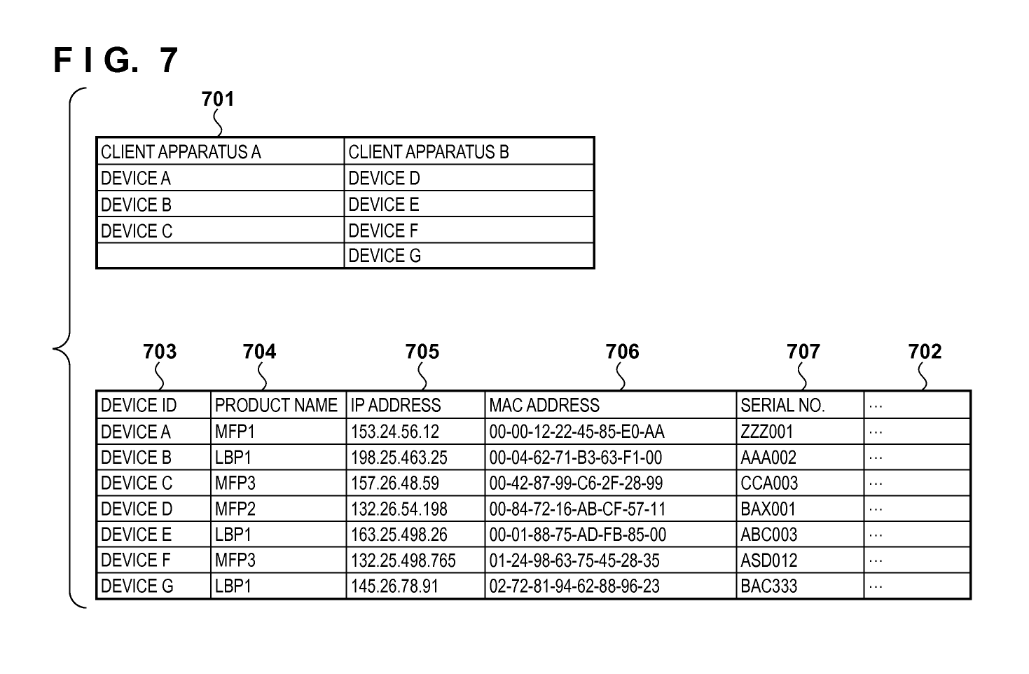

FIG. 7 is a diagram showing management device lists set in the management apparatus. A management device list 701 is a list of the devices to be managed that is set in the management apparatus 106. Specifically, the management device list 701 is a list that correlates each of the site monitoring apparatuses 113a and 113b with the devices that are to be monitored. The management device list 701 is managed by the client management unit 502, and associates the client apparatus IDs of the site monitoring apparatuses 113a and 113b with the device ID of the device 112.

A device list 702 indicates the configuration information of the device 112. The device list 702 includes information such as a device ID 703 assigned to the device 112, a product name 704, an IP address 705, a MAC address 706, and a serial number 707. The device list 702 is managed by the device management unit 503. Although the management device list and the configuration information of the device are defined in separate tables in the first embodiment, they may be managed in the same table.

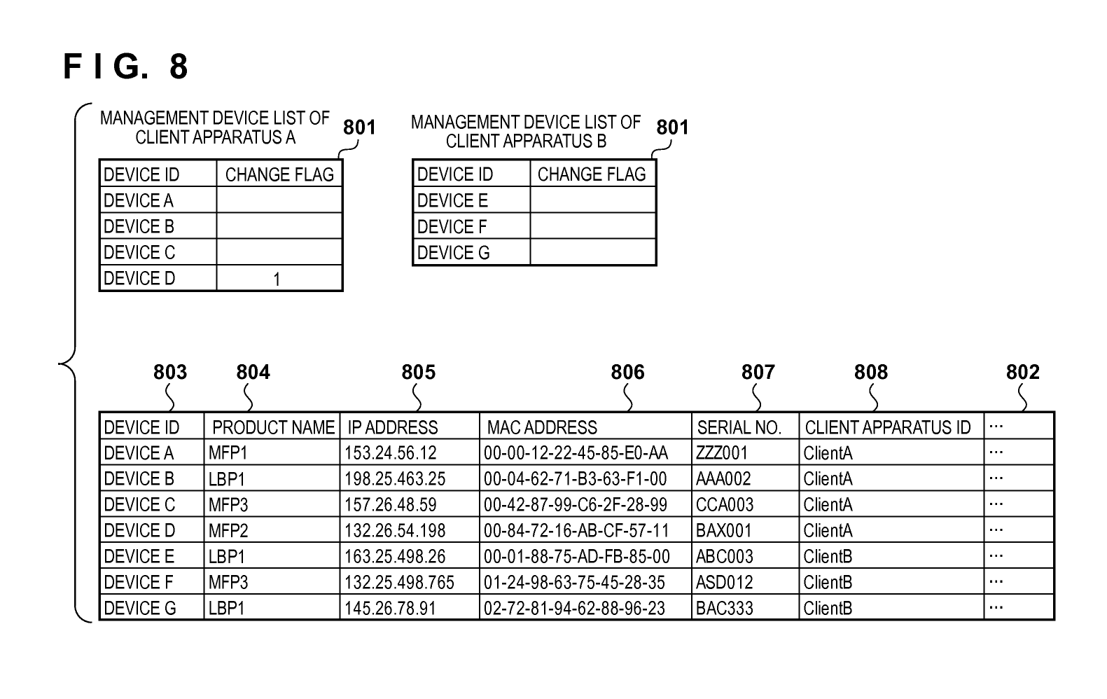

FIG. 8 is a diagram showing management device lists set in the analysis apparatus. A management device list 801 is a list of the devices to be managed that is set in the analysis apparatus 102. Specifically, the management device list 801 is a list that correlates each of the site monitoring apparatuses 113a and 113b with the devices that are to be monitored. The management device list 801 is managed by the client management unit 602, and associates the client apparatus IDs of the site monitoring apparatuses 113a and 113b with the device ID of the device 112. The device ID indicates a device ID 803, which will be described below. In addition, the management device list 801 is configured to be able to add a change flag to each device (each device ID). The change flag is added to the record of a device to which a change has occurred before and after update when there has been a change in the association between each of the site monitoring apparatuses 113a and 113b and the device.

A device list 802 indicates the configuration information of the device 112. The device list 802 includes information such as a device ID 803, which is the ID of the device 112, a product name 804, an IP address 805, a MAC address 806, and a serial number 807. In addition, the device list 802 includes a client apparatus ID as information on the site monitoring apparatuses 113a and 113b that manages the device. The device list 802 is managed by the device management unit 603. Although the management device list and the configuration information of the device are defined in separate tables in the first embodiment, they may be managed in the same table.

Management Device Lists in Monitoring Apparatus

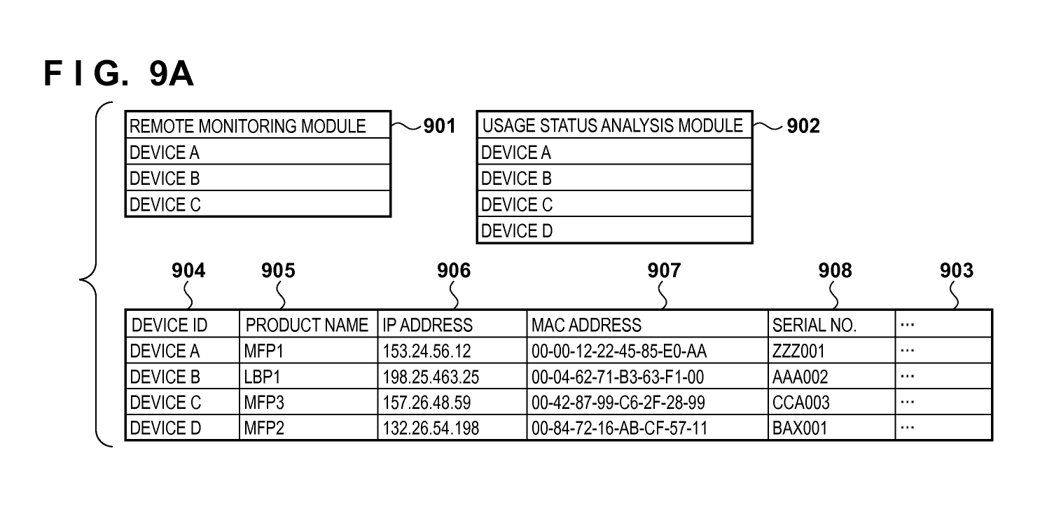

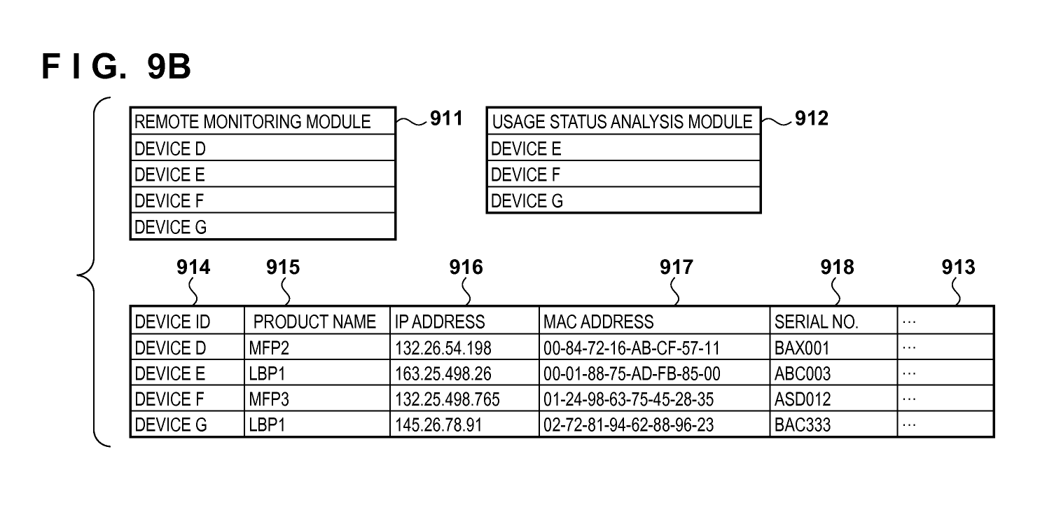

FIGS. 9A and 9B are diagrams showing management device lists set in the site monitoring apparatus. FIG. 9A shows the management device lists of the respective modules that are set in the site monitoring apparatus 113a. On the other hand, FIG. 9B shows the management device lists of the respective modules that are set in the site monitoring apparatus 113b. Note that FIG. 9B is substantially the same as FIG. 9A except that the devices to be managed are different, and therefore, a description will be given below only of FIG. 9A.

A management device list 901 is the management device list of the remote monitoring module. In other words, the management device list 901 is a list of devices for which the information indicating the operating state and the counter information are transmitted to the monitoring system 101. The device IDs of the devices that are to be managed by the monitoring system 101 are saved in the management device list 901 of the remote monitoring module.

A management device list 902 is the management device list of the usage status analysis module. In other words, the management device list 902 is a list of devices for which various types of data of the devices are transmitted to the usage status analysis system 100. The device IDs of the devices that are to be managed by the usage status analysis system 100 are saved in the usage status analysis module management device list 902.

The management device list 901 of the remote monitoring module and the management device list of the usage status analysis module are managed by the module management unit 406.

A device list 903 shows the configuration information of each of the devices that are to be managed by the site monitoring apparatus 113a. The device list 903 includes information such as a device ID 904, which is the ID of the device 112, a product name 905, an IP address 906, a MAC address 907, and a serial number 908. The device list 903 is managed by the device information management unit 403. Although the management device list and the configuration information of the device are defined in separate tables in the first embodiment, they may be managed in the same table.

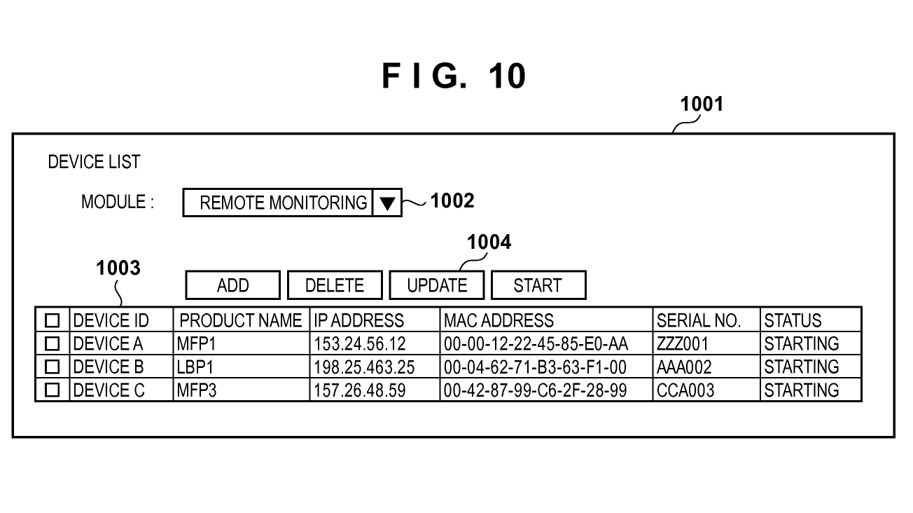

FIG. 10 is a diagram showing an example of the UI screen that displays the management device lists of the site monitoring apparatus. A UI screen 1001 is a screen that displays the management device lists of the site monitoring apparatuses 113 and 118. By clicking a pull-down button 1002 using, for example, a mouse, the management device list can be displayed for each module. A management device list display 1003 displays the configuration information of each device. As the configuration information, the same content as that of the device list to be displayed (in the case of FIG. 10, the device list 901) is displayed. The status indicating whether the monitoring by each module has been started is also displayed. Additionally, by clicking a button 1004 using, for example, a mouse, it is possible to provide an instruction to start addition, deletion, update of display, and monitoring of a device that is to be managed.

Operation of Apparatuses in System

As described above, in the site monitoring apparatuses 113 and 118, the timing at which various types of information are transmitted to the usage status analysis system 100 and the timing at which various types of information are acquired from the devices 112 and 117 are different. In general, in order to provide the latest possible information, a period that can meet the timing at which various types of information are transmitted to the usage status analysis system 100 is set as the period during which various types of information are acquired from the devices.

However, when the management device list is updated during the period during which the site monitoring apparatus acquires various types of information from the devices, the timing at which the various types of information are acquired from the updated device may occur after the update of the management device list. In this case, various types of information on the updated device will not be transmitted at the next timing of transmission of various types of information of the device to the usage status analysis system 100. For example, when the next transmission of the various types of information is performed across days, this may not be performed by the deadline of a monthly report of the usage status analysis system 100, and the information will be reflected in the report for the next month. The following describes a method for updating the management device lists to solve such a problem.

Operation for Updating Management Device Lists in Site Monitoring Apparatus

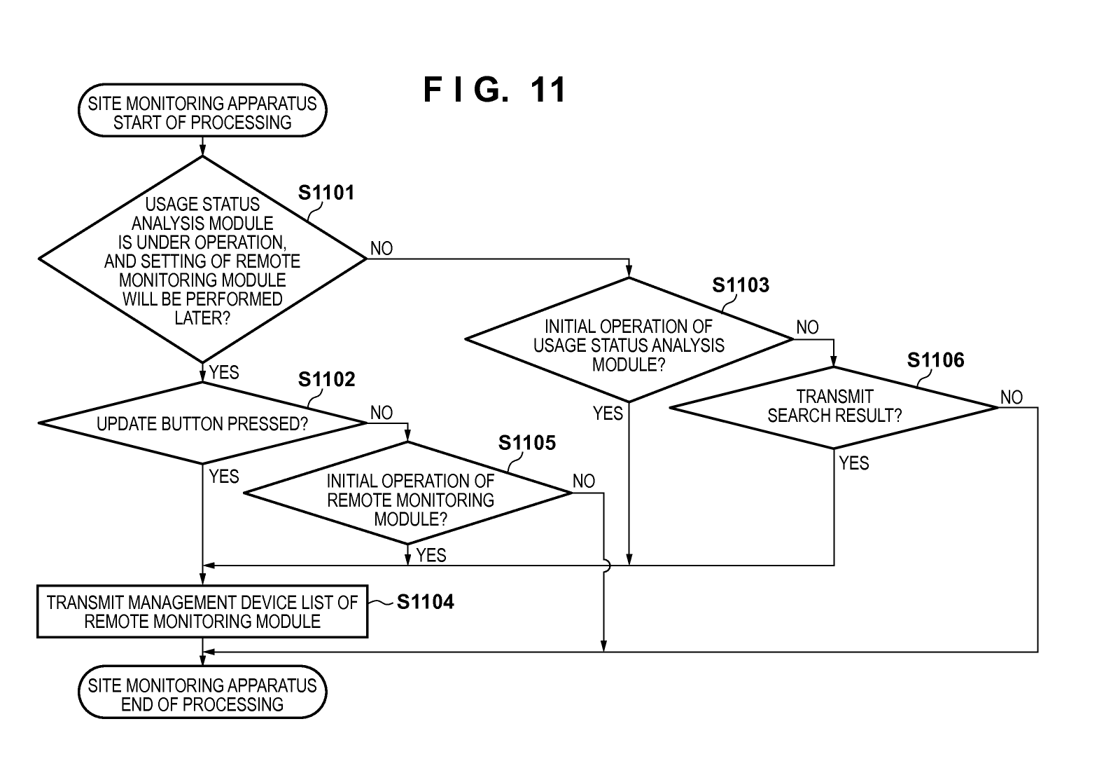

FIG. 11 is a flowchart illustrating an operation for updating the management device lists in the site monitoring apparatus. Note that the processes at the steps in the flowchart are implemented by the CPU 201 provided in each of the site monitoring apparatuses 113 and 118 reading and executing a predetermined control program stored in a storage unit such as the ROM 202 or the HDD 205.

At step S1101, the module management unit 406 determines whether the usage status analysis module is under operation and a remote monitoring module has been newly added. Specifically, the module management unit 406 determines which of the initial setting of the usage status analysis system 100 and the initial setting of the monitoring system 101 has been completed earlier. If the usage status analysis module is previously under operation, the process proceeds to step S1102. On the other hand, if the remote monitoring module is previously under operation, the process proceeds to step S1103.

At step S1102, the screen control unit 410 determines whether the “update” button 1004 has been pressed on the UI screen 1001 that displays the management device list. If the update button 1004 has been pressed, the process proceeds to step S1104. On the other hand, if the update button 1004 has not been pressed, the process proceeds to step S1105.

At step S1104, the communication unit 405 transmits the management device list 901 (specifying information) of the remote monitoring module to the usage status analysis system 100.

At step S1105, the module management unit 406 determines whether the operation is the initial operation (the first execution) of the remote monitoring module. If it is the initial operation, the process proceeds to step S1104. On the other hand, if it is not the initial operation, the process ends.

At step S1103, the module management unit 406 determines whether the operation is the initial operation of the usage status analysis module. If it is the initial operation, the process proceeds to step S1105. On the other hand, if it is not the initial operation, the process proceeds to step S1106.

At step S1106, the device information management unit 403 determines whether or not to transmit a search result of the device to the usage status analysis system 100. If it is to be transmitted, the process proceeds to step S1105. On the other hand, if it is not to be transmitted, the process ends.

Note that the timing at which the site monitoring apparatuses 113 and 118 transmit the management device lists of the remote monitoring module to the usage status analysis system 100 may be any timing.

Operation for Changing Management Device Lists in Analysis Apparatus

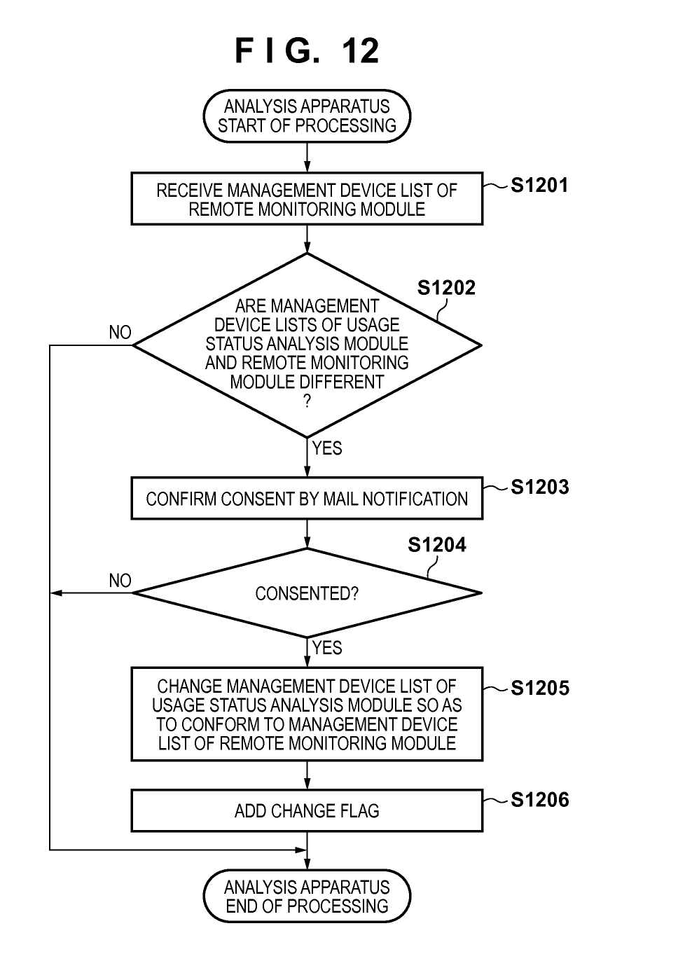

FIG. 12 is a flowchart illustrating an operation for changing the management device lists in the analysis apparatus. Note that the processes at the steps in the flowchart are implemented by the CPU 201 provided in the analysis apparatus 102 reading and executing a predetermined control program stored in a storage unit such as the ROM 202 or the HDD 205.

At step S1201, the communication unit 611 receives the management device lists 901 and 911 of the remote monitoring module that are transmitted from the site monitoring apparatuses 113 and 118. In the communication between the usage status analysis system 100 and the site monitoring apparatuses 113 and 118, authentication is performed by exchanging the client apparatus ID, the customer ID, and the authentication key of the site monitoring apparatuses 113 and 118. When authentication has been achieved, the analysis apparatus 102 starts the reception of various types of information transmitted from the site monitoring apparatuses 113 and 118, and stores the information in the database 103.

At step S1202, the received data analysis unit 609 determines whether the management device lists 901 and 911 of the remote monitoring module are different from the already-registered management device list 801 of the usage status analysis module that is currently managed by the usage status analysis system 100. If they are different, the process proceeds to step S1203. On the other hand, if they are the same, the process ends.

At step S1203, the mail processing unit 606 transmits a mail notifying that the management device list 801 of the usage status analysis module is different from the management device lists 901 and 911 of the remote monitoring module to the site monitoring apparatus. The specific destination of the mail is an address that is set in the analysis apparatus 102 in advance. The mail describes the content that confirms consent (permission) to change the management device list 801 of the usage status analysis module in conformity to the management device lists 901 and 911 of the remote monitoring module. For example, an URL for inputting the confirmation of consent to the change is described, and an input indicating the consent is made on the screen of the URL. A “consent” button and a “not consent” button are provided on the transition destination screen, which is the user interface screen, and whether consent has been made is determined by the pressing of either of the buttons. Note that it is possible to adopt a configuration in which consent is received through a pop-up notification on the UI screen, instead of using a mail.

At step S1204, the screen control unit 612 determines whether consent from the user has been received. If the consent has been received, the process proceeds to step S1205. On the other hand, if no consent has been received, the process ends.

At step S1205, the client management unit 602 changes the management device list 801 of the usage status analysis module in conformity to the management device lists 901 and 911 of the remote monitoring module. Note that the reason why the management device list 801 of the usage status analysis module is changed here is that the management device list of the monitoring system 101 is often in a more optimum device configuration. That is, as described above, in the monitoring system 101, the setting of the managed devices in the site monitoring apparatuses 113 and 118 has been performed by the serviceman who has gone to the location of installation, and it is therefore expected that the device configuration is made suitable for the environment of the customer system.

At step S1206, the client management unit 602 adds a change flag 801 to the record of a device to which a change has made.

Operation for Setting Management Device Lists in Site Monitoring Apparatus

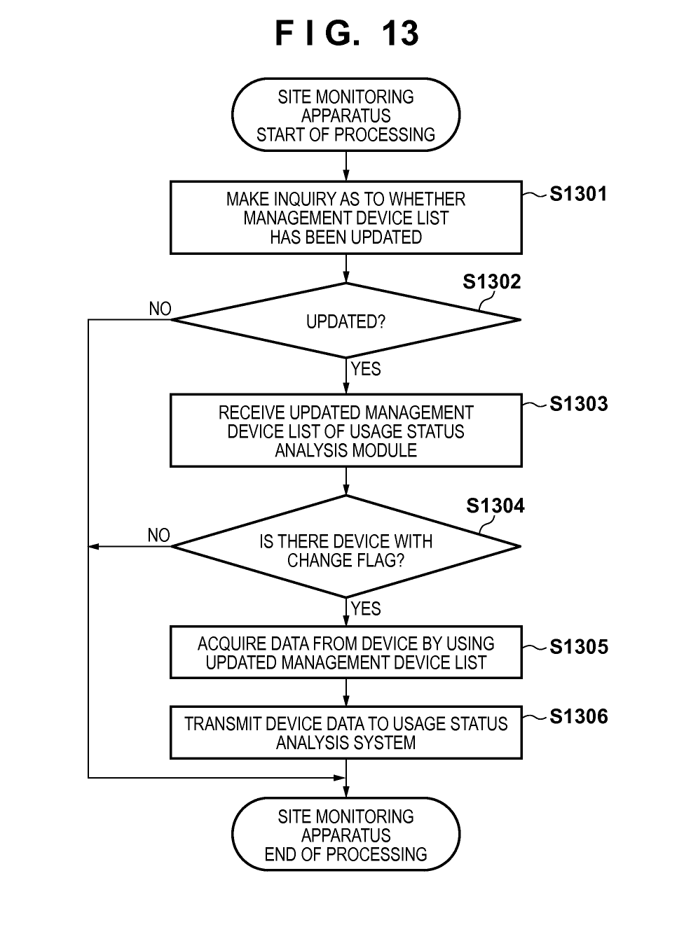

FIG. 13 is a flowchart illustrating an operation for setting the management device lists in the site monitoring apparatus. Note that the processes at the steps in the flowchart are implemented by the CPU 201 provided in each of the site monitoring apparatuses 113 and 118 reading and executing the control program stored in a storage unit such as the ROM 202 or the HDD 205.

At step S1301, the module management unit 406 makes an inquiry to the usage status analysis system 100 as to whether the management device lists 902 and 912 of the usage status analysis module have been updated. The timing of inquiry may be any timing, and is determined depending on whether the inquiry is performed, for example, by a regular polling or by an instruction from the UI screen.

At step S1302, if a reply indicating that update has been made is sent as a result of making an inquiry at S1301, the module management unit 406 proceeds to step S1303. On the other hand, if no update has been made, the process ends.

At step S1303, the module management unit 406 receives the updated management device list 801 (update information) of the usage status analysis module from the analysis apparatus 102.

At step S1304, the received data analysis unit 407 determines whether there is a device with a change flag in the received management device list of the usage status analysis module. If there is a device with a change flag, the process proceeds to step S1305. On the other hand, if there is no device with a change flag, the process ends.

At step S1305, the device information acquisition unit 402 acquires, from the devices included in the received management device list, the device information that is to be transmitted to the usage status analysis system 100. This process is executed promptly after it has been determined at step S1304 that there is a device with a change flag.

At step S1306, the transmission data generation unit 408 transmits the device information acquired at step S1305 to the usage status analysis system 100. This process is executed promptly after the process at step S1305. Here, the information on all the devices included in the management device lists is acquired and transmitted to the usage status analysis system 100. However, only the information on the device with a change flag may be transmitted.

Updating the management device lists by the above-described procedure enables the management device lists in the usage status analysis system 100 and the management device lists in the monitoring system 101 to be managed favorably. That is, even if a management device list of the usage status analysis system 100 has been updated during the period during which the site monitoring apparatus acquires various types of information from the devices, it is possible to appropriately transmit the various types of information on the devices to the usage status analysis system 100.

As described thus far, with the system according to the first embodiment, it is possible to appropriately control the device information of the devices managed by a plurality of systems. For example, it is possible to ensure the consistency of the device information (e.g., various counter values) notified to the plurality of systems.

Variation

In the first embodiment described above, the communication unit 405 of the site monitoring apparatus is configured to transmit the management device lists of the remote monitoring module to the usage status analysis system 100 at step S1104. However, the communication unit 405 may be configured to transmit the identification information (specifying information) set in the remote monitoring module. In the following, a description will be given of operations of the analysis apparatus and the site monitoring apparatus when the identification information set in the remote monitoring module is transmitted.

Operation for Updating Management Device Lists in Analysis Apparatus

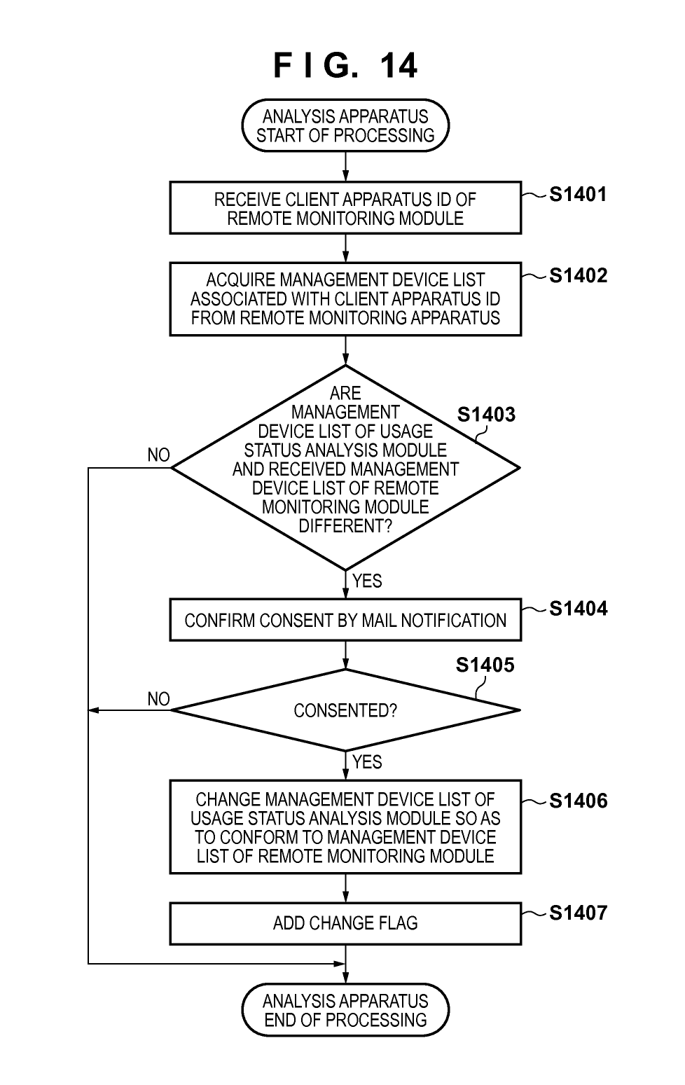

FIG. 14 is a flowchart illustrating an operation for updating the management device lists in the analysis apparatus according to a variation.

At step S1401, the received data analysis unit 609 receives the identification information of the remote monitoring module.

At step S1402, the system cooperative processing unit 607 acquires the management device list associated with the identification information received at the step S1401 via the Web Service I/F of the monitoring system 101.

Steps S1403 to S1407 are the same as steps S1202 to step S1206 in the first embodiment, and therefore, the description thereof has been omitted.

Operation for Setting Management Device Lists in Site Monitoring Apparatus

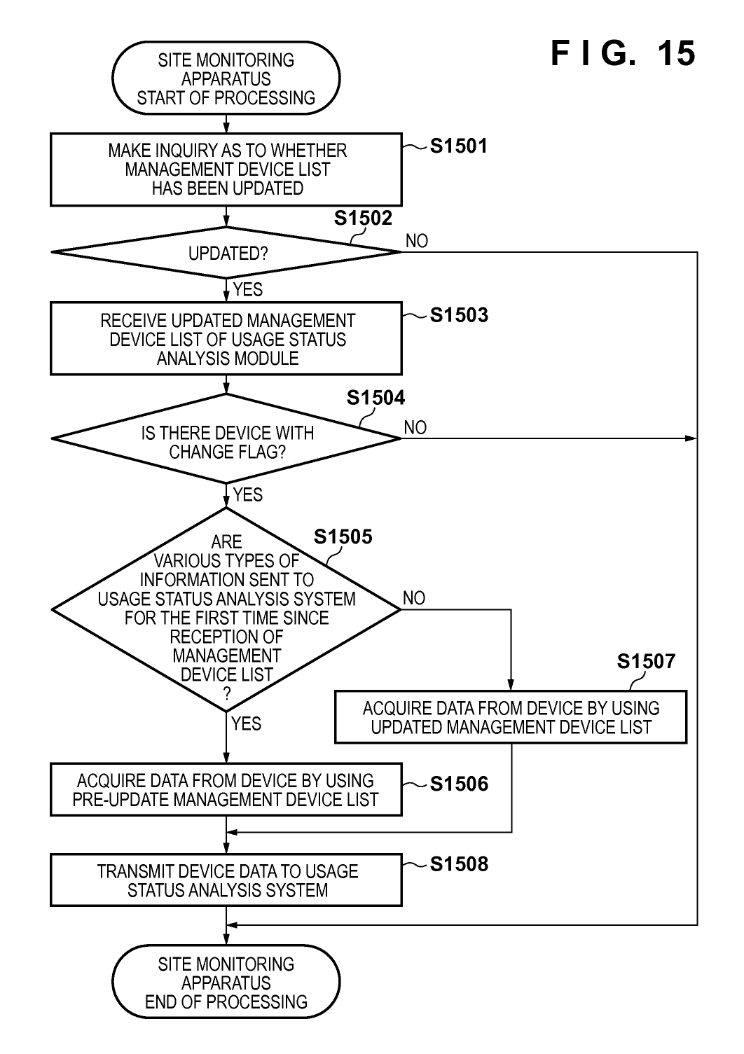

FIG. 15 is a flowchart illustrating an operation for setting the management device lists in the site monitoring apparatus according to a variation.

At step S1501, the module management unit 406 makes an inquiry to the usage status analysis system 100 as to whether the management device lists 902 and 912 of the usage status analysis module have been updated. The timing of inquiry may be any timing, and is determined depending on whether the inquiry is performed, for example, by a regular polling or by an instruction from the UI screen.

At step S1502, if a reply indicating that update has been made is sent as a result of making an inquiry at S1501, the module management unit 406 proceeds to step S1503. On the other hand, if no update has been made, the process ends.

At step S1503, the module management unit 406 receives the updated management device lists (update information) of the usage status analysis module from the analysis apparatus.

At step S1504, the received data analysis unit 407 determines whether there is a device with a change flag in the received management device lists 902 and 912 of the usage status analysis module. If there is a device with a change flag, the process proceeds to step S1505. On the other hand, if there is no device with a change flag, the process ends.

At step S1505, the schedule management unit 401 determines whether the transmission timing of the device information to the usage status analysis system 100 is the first transmission timing after acquisition of the management device lists. If it is the first transmission timing, the process proceeds to step S1506. If it is not the first transmission timing (the second or subsequent transmission), the process proceeds to step S1507.

At step S1506, the device information acquisition unit 402 acquires various types of information from the devices by using the pre-update (existing) management device lists of the usage status analysis module. On the other hand, at step S1507, the device information acquisition unit 403 acquires various types of information from the devices by using the updated management device lists of the usage status analysis module.

At step S1508, the transmission data generation unit 408 transmits the information acquired at step S1506 and step S1507 to the usage status analysis system 100.

As described above, with the system according to a variation, it is possible to appropriately control the device information of the devices managed by a plurality of systems.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-210589, filed Oct. 7, 2013 which is hereby incorporated by reference herein in its entirety.

What is claimed is:

1. An information processing system comprising: a site monitoring apparatus configured to collect device information from image forming apparatuses; and a usage status analysis system configured to receive the device information from the site monitoring apparatus via a network and to analyze the received device information,
wherein the site monitoring apparatus includes:
a first management unit configured to manage a first device list including an image forming apparatus that is to be monitored by a first module for providing a function of communicating with a monitoring system;
a second management unit configured to manage a second device list including an image forming apparatus that is to be monitored by a second module for providing a function of communicating with the usage status analysis system;
a first transmission unit configured to transmit specifying information for specifying the first device list to the usage status analysis system by using the function of the second module;
a first reception unit configured to receive update information conforming to the specifying information from the usage status analysis system; and
an update unit configured to update the second device list managed by the second management unit by using the received update information,
the usage status analysis system includes:
a second reception unit configured to receive the specifying information from the site monitoring apparatus; and
a second transmission unit configured to transmit, to the site monitoring apparatus, the update information that has been generated based on the specifying information.

2. The information processing system according to claim 1,
wherein the usage status analysis system generates, based on a plurality of first device lists that are specified from a plurality of pieces of specifying information transmitted from a plurality of site monitoring apparatuses, a plurality of pieces of update information for updating the second device list in each of the plurality of site monitoring apparatuses, and the second transmission unit transmits each of the plurality of pieces of update information to the site monitoring apparatus corresponding thereto.

3. The information processing system according to claim 1,
wherein the specifying information for specifying the first device list is the first device list itself,
the usage status analysis system is configured to update the second device list so as to conform to the first device list, and set a change flag for a device to which a change has been made by the update, and,
when an image forming apparatus to which the change flag has been added is included in the second device list received from the usage status analysis system, the site monitoring apparatus collects the device information from each of the image forming apparatuses included in the received second device list, and provides the collected device information to the usage status analysis system.

4. The information processing system according to claim 1,
wherein the specifying information for specifying the first device list is identification information for identifying the first module, and
the usage status analysis system makes an inquiry for the first device list to the monitoring system by using the identification information received by the second reception unit.

5. The information processing system according to claim 4,
wherein the usage status analysis system is configured to update the second device list so as to conform to the first device list, and set a change flag for a device to which a change has been made by the update, and,
when an image forming apparatus to which the change flag has been added is included in the second device list received from the usage status analysis system, the site monitoring apparatus collects the device information from each of the image forming apparatuses included in the existing second device list and provides the collected device information to the usage status analysis system during an initial collection of the device information after acquisition of the received second device list, and collects the device information from each of the image forming apparatuses included in the received second device list and provides the collected device information to the usage status analysis system during a second and subsequent collections of the device information after acquisition of the received second device list.

6. The information processing system according to claim 1,
wherein the device information includes counter information indicating a usage frequency of a predetermined functional unit included in the image forming apparatus.

7. The information processing system according to claim 1,
wherein, when the first device list specified by the specifying information and the existing second device list differ from each other, the usage status analysis system makes an inquiry to the site monitoring apparatus as to whether or not to permit update of the second device list, and updates the second device list, if the update is permitted by the site monitoring apparatus.

8. The information processing system according to claim 7,
wherein the site monitoring apparatus includes a display unit configured to display a user interface screen for receiving from a user, a designation as to whether or not to permit update of the second device list when an inquiry as to whether or not to permit update of the second device list is received from the usage status analysis system.

9. A site monitoring apparatus comprising:
a first management unit configured to manage a first device list including an image forming apparatus that is to be monitored by a first module for providing a function of communicating with a monitoring system;
a second management unit configured to manage a second device list including an image forming apparatus that is to be monitored by a second module for providing a function of communicating with a usage status analysis system;
a transmission unit configured to transmit specifying information for specifying the first device list to the usage status analysis system by using the function of the second module;
a reception unit configured to receive update information conforming to the specifying information from the usage status analysis system; and
an update unit configured to update the second device list managed by the second management unit by using the received update information.

10. An information processing method performed in an information processing system including: a site monitoring apparatus configured to collect device information from image forming apparatuses; and a usage status analysis system configured to receive the device information from the site monitoring apparatus via a network and to analyze the received device information,
wherein the site monitoring apparatus includes:
a first management unit configured to manage a first device list including an image forming apparatus that is to be monitored by a first module for providing a function of communicating with a monitoring system; and
a second management unit configured to manage a second device list including an image forming apparatus that is to be monitored by a second module for providing a function of communicating with a usage status analysis system,
the information processing method comprises:
transmitting, by the site monitoring apparatus, specifying information for specifying the first device list to the usage status analysis system by using the function of the second module;
receiving, by the usage status analysis system, the specifying information from the site monitoring apparatus;
transmitting, by the usage status analysis system, update information that has been generated based on the specifying information to the site monitoring apparatus,
receiving, by the site monitoring apparatus, the update information conforming to the specifying information from the usage status analysis system; and
updating, by the site monitoring apparatus, the second device list managed by the second management unit by using the received update information.

11. An information processing method performed in a site monitoring apparatus including:
a first management unit configured to manage a first device list including an image forming apparatus that is to be monitored by a first module for providing a function of communicating with a monitoring system; and
a second management unit configured to manage a second device list including an image forming apparatus that is to be monitored by a second module for providing a function of communicating with a usage status analysis system, the method comprising:
transmitting specifying information for specifying the first device list to the usage status analysis system by using the function of the second module;
receiving update information conforming to the specifying information from the usage status analysis system; and
updating the second device list managed by the second management unit by using the received update information.

12. A non-transitory computer-readable recording medium storing a program that causes a computer to function as each of the units of the image forming apparatus according to claim 9.
